(19) United States
(12) Patent Application Publication
(10) Pub. No.: US 2016/0368555 A1
(43) Pub. Date: Dec. 22, 2016

(54) ILLUMINATED BICYCLE HANDLEBAR SYSTEM

(71) Applicants: Brian Peterson, Miami, FL (US); Jonathan Perkins, Miami, FL (US)

(72) Inventors: Brian Peterson, Miami, FL (US); Jonathan Perkins, Miami, FL (US)

(21) Appl. No.: 14/740,509

(22) Filed: Jun. 16, 2015

(51) Int. Cl. B62J 6/00; F21V 3/04; F21S 10/06; F21S 9/02; B62K 21/12; F21V 23/04

(52) U.S. Cl. CPC B62J 6/003; B62K 21/12; F21V 23/04; F21S 10/06; F21S 9/02; F21V 3/0445; F21Y 2113/005

(57) ABSTRACT

An the illuminated handlebar for a bicycle comprises a hardened metal core comprising at least one elongated element, a translucent polyurethane exterior disposed over at least a portion of the hardened metal core, a portable DC voltage source coupled to a portion of the hardened metal core, wherein the voltage source is configured for installation and removal by a hand of a user without the use of tools, a plurality of light emitting diode (LED) units conductively coupled to the voltage source, wherein the plurality of LED units contact at least a portion of the polyurethane exterior such that light emitted forwardly therefrom generally travels along the polyurethane exterior, a switch for turning the plurality of LED lights on and off, and a fastening element coupled to the hardened metal core for coupling to a stem of a bicycle.

### CROSS-REFERENCE TO RELATED APPLICATIONS

Not Applicable.

### STATEMENT REGARDING FEDERALLY SPONSORED RESEARCH OR DEVELOPMENT

Not Applicable.

### INCORPORATION BY REFERENCE OF MATERIAL SUBMITTED ON A COMPACT DISC

Not Applicable.

### TECHNICAL FIELD

The present invention relates to the field of bicycles, and more specifically to the field of bicycle safety.

### BACKGROUND

Bicycles were introduced in the 19th century and now number over one billion worldwide. They are the principal means of transportation in many parts of the world. Consequently, there are millions of bicycles on the road in every country on Earth. Many individuals enjoy riding bicycles for long distances, and sometimes at high speeds. Today's composite material technology has resulted in lighter and faster bicycles, which facilitates bicycling at high speeds. Because of the increased speed, bicycle riding has become increasingly more dangerous.

It is common to see bicycles and bicycle riders involved in accidents with automobiles as well as with pedestrians. This is especially true at night time or in the dark. Often, the reason for said accidents is that the bicycle is not highly visible to the automobile driver or pedestrian. In the past, many individuals have used reflectors on bicycles and on the clothing of the riders, in order to appear more visible to others. But this solution has had limited success. While this is an improvement, said reflectors do not always make the bicycle as visible as necessary. For instance, reflectors may not be seen by an automobile driver at various angles. Another improvement in bicycle visibility that has been utilized in the past is the use of lights on the front of the bicycle. If an automobile is approaching from behind, however, a person is still unable to see the bicycle. Additionally, the use of a few reflectors may make it apparent to a driver that something is there, but it may still be difficult for an observer to determine exactly the type of object being viewed.

Another improvement in bicycle visibility is the utilization of multiple lights in the front and back of the bicycle. While this is also an improvement, this requires multiple battery sources and also increases the amount of purchases that a user is required to make. Additionally, this improvement requires a user to mount lights on multiple parts on the exterior of the bicycle, which may be lost or damaged when the bicycle accidentally or intentionally falls to the ground.

Furthermore, there has been a burgeoning interest in fashionable and stylized bicycles. The hipster movement in the United States, for example, has created a renewed interest in bicycles, and to this end, artistic expression has started to enter the realm of bicycle construction and bicycle accessories. Therefore, raised awareness regarding bicycle aesthetics has prompted bicycle enthusiasts to explore new ways of decorating their bicycles and making them more aesthetically appealing. But the area of bicycle aesthetics, however, is still in its infancy, since few options are currently available for many common bicycle parts.

As a result, there exists a need for improvements over the prior art and more particularly for a more efficient way and safer way for a user of a bicycle to become more visible during the night, while also providing additional ways of improving the aesthetics of bicycles.

### SUMMARY

An illuminated handlebar for a bicycle is disclosed. This Summary is provided to introduce a selection of disclosed concepts in a simplified form that are further described below in the Detailed Description including the drawings provided. This Summary is not intended to identify key features or essential features of the claimed subject matter. Nor is this Summary intended to be used to limit the claimed subject matter's scope.

In one embodiment, the illuminated handlebar for a bicycle comprises a hardened metal core comprising at least one elongated element, a translucent polyurethane exterior disposed over at least a portion of the hardened metal core, a portable DC voltage source coupled to a portion of the hardened metal core, wherein the voltage source is configured for installation and removal by a hand of a user without the use of tools, a plurality of light emitting diode (LED) units conductively coupled to the voltage source, wherein the plurality of LED units contact at least a portion of the polyurethane exterior such that light emitted forwardly therefrom generally travels along the polyurethane exterior, a switch for turning the plurality of LED lights on and off, and a fastening element coupled to the hardened metal core for coupling to a stem of a bicycle.

Additional aspects of the disclosed embodiment will be set forth in part in the description which follows, and in part will be obvious from the description, or may be learned by practice of the disclosed embodiments. The aspects of the disclosed embodiments will be realized and attained by means of the members and combinations particularly pointed out in the appended claims. It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute part of this specification, illustrate embodiments of the invention and together with the description, serve to explain the principles of the disclosed embodiments. The embodiments illustrated herein are presently preferred, it being understood, however, that the invention is not limited to the precise arrangements and instrumentalities shown, wherein:

FIG. 1 is a perspective view of a bicycle utilizing an illuminated handlebar, according to an example embodiment;

FIG. 2 is a cross sectional side view of an illuminated handlebar, according to an example embodiment; and

FIG. 3 is a cross sectional side view of a component of an illuminated handlebar, according to an example embodiment.

### DETAILED DESCRIPTION

The following detailed description refers to the accompanying drawings. Whenever possible, the same reference numbers are used in the drawings and the following description to refer to the same or similar members. While disclosed embodiments may be described, modifications, adaptations, and other implementations are possible. For example, substitutions, additions or modifications may be made to the members illustrated in the drawings, and the methods described herein may be modified by substituting reordering, or adding additional stages or components to the disclosed methods and devices. Accordingly, the following detailed description does not limit the disclosed embodiments. Instead, the proper scope of the disclosed embodiments is defined by the appended claims.

The disclosed embodiments improve upon the problems with the prior art by providing a system a system for illuminating a bicycle via its handlebars. The system improves bicycle safety providing a system for illuminating a bicycle that allows an observer to clearly distinguish that the object is a bicycle, even at night or in low light conditions. Additionally, the system improves over the prior art by having all substantive components of the illumination system held inside of a housing, thereby protecting the system from falls or other traumatic events. Further, the system improves usability of the product by allowing a user to easily install the system, as well as to easily remove or replace the power source of the system, without requiring the use of tools. Lastly, the system improves over the prior art by providing a new and useful ways of decorating bicycles and making them more aesthetically appealing.

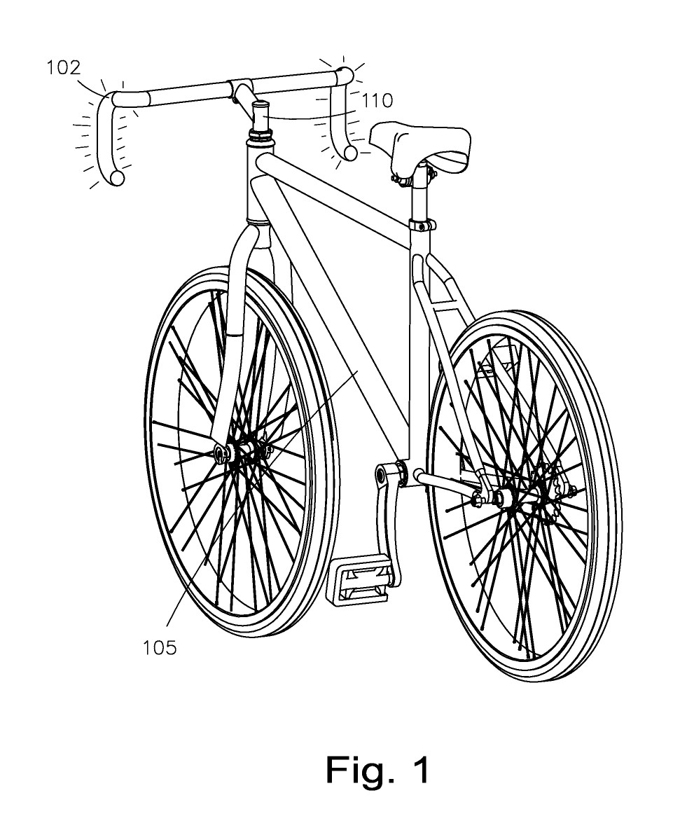

Referring now to the Figures, FIG. 1 is a perspective view of a bicycle 105 utilizing an illuminated handlebar 102, according to an example embodiment. The illuminate handlebar 102 is attached to the stem 110 of the bicycle 105. Each of the tubular members comprising the frame of the bicycle 105 can be made from material comprising steel, high performance alloys, aluminum alloys, titanium, carbon fiber, cardboard and even bamboo or any combinations thereof. The stem is the component on a bicycle that connects the handlebars to the steerer tube of the bicycle fork. Sometimes called a goose neck, a stem's design belongs to either a quill or threadless system, and each system is compatible with respective headset and fork designs. In a quill system, the stem inserts into the steerer tube, which is threaded and does not extend above the headset. In a threadless system, the stem clamps around the steerer tube, which is not threaded and extends above the headset. The headset is the set of components on a bicycle that provides a rotatable interface between the bicycle fork and the head tube of the bicycle frame itself.

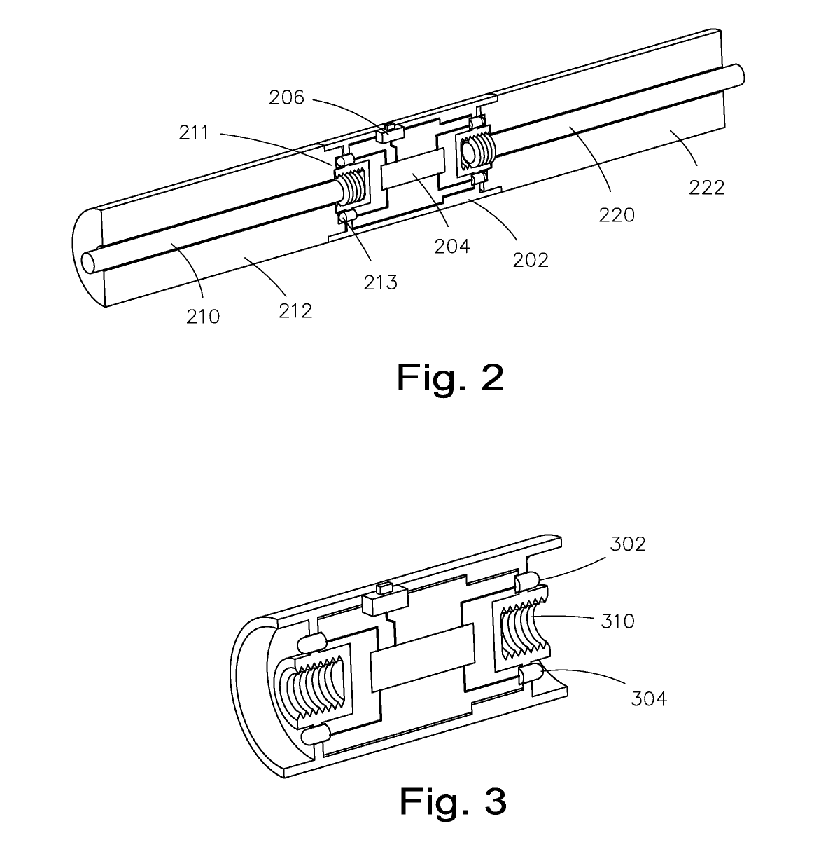

FIG. 2 is a cross sectional side view of the illuminated handlebar 102, while FIG. 3 is a cross sectional side view of the housing component 202 of the illuminated handlebar 102. The illuminated handlebar 102 includes a housing 202 that houses various substantive components of the device 102, such as the battery pack, the LED lights, etc. The housing may be located at a midpoint of the handlebar 102 and configured for coupling to the stem 110 of the bicycle 105. The illuminated handlebar 102 also includes a portable DC voltage source 204 located within the housing 202, wherein the voltage source is configured for installation and removal by a hand of a user without the use of tools. For example, the housing may include a hatch or port that opens and provides access to the voltage source. In another example, the first or second metal cores (and attached polyurethane exterior) may unscrew from the housing and provide access to the voltage source. Further, the voltage source may be recharegeable batteries, such as including lead-acid, nickel cadmium (NiCd), nickel metal hydride (NiMH), lithium ion (Li-ion), and lithium ion polymer (Li-ion polymer) batteries. It is also worth noting that in one alternative, the power source may be attached or coupled to various parts of the bicycle 105, even exterior components.

The illuminated handlebar 102 also includes a switch 206 for turning the plurality of LED lights on and off. The switch may be conductively coupled with the power source 204.

The illuminated handlebar 102 also includes first elongated element comprising a hardened metal core 210 coupled to a left side of the housing 202 and extending out in the left direction from the housing. The hardened metal core 210 provides the structural component of the left side of the handlebar 102 that is used by the left hand of the rider of the bicycle 105. The illuminated handlebar 102 also includes a second elongated element comprising a hardened metal core 220 coupled to a right side of the housing 202 and extending out in the right direction from the housing. The hardened metal core 220 provides the structural component of the right side of the handlebar 102 that is used by the right hand of the rider of the bicycle 105. The elongated elements may comprise of metal, alloy, carbon fiber, graphite, etc., which is well known to those skilled in the art. Also, the elongated elements may be coupled to the housing 202 by screwing a threaded end of each elongated element into a female threaded depression (such as 310) in the housing 202. Alternatively, each of the elongated elements can be affixed by welding, fasteners, etc. to the housing 102 and in other ways well known to those skilled in the art. The elongated elements can be formed from a mold adapted to form each of the elements.

The illuminated handlebar 102 also includes a translucent polyurethane exterior 212, 222 disposed over at least a portion of the first and second elongated elements. Polyurethane is a polymer composed of a chain of organic units joined by carbamate (urethane) links. Each translucent polyurethane exterior element 212, 222 may be formed like a tube, so as to accommodate the first and second elongated elements within each polyurethane exterior element.

The illuminated handlebar 102 also includes a plurality of light emitting diode (LED) units 211, 213, 302, 304 conductively coupled to the voltage source 204, wherein the plurality of LED units contact at least a portion of the polyurethane exterior 212, 222 such that light emitted forwardly therefrom generally travels along the polyurethane exterior. Note that the translucent polyurethane exterior elements allow light to pass through the material without being scattered, and allows the illumination of the polyurethane exterior elements, which appears to the external viewer as if the entire handlebar 102 is illuminated.

The LED lights are also sized and adapted to fit inside the housing 202. The light emanating from the illuminating LED bulbs passes through the translucent polyurethane exterior elements and can be seen by an external viewer. The LED bulbs can be arranged as a string of lights conductively coupled with an insulated wire, and may also be an LED strip, an LED string, a lightbulb strip, a lightbulb string, etc. or any combinations thereof. The lights can be a variety of color combinations or can be adapted for changing colors or turning on and off at various intervals of time. The lights may change color or be adapted to have a certain color for allowing a user to demonstrate his or her patriotism for a particular team or purpose.

The LED lights are connected to a removable power source via an insulated cable or wire. Such wires and cables are well known to those skilled in the art. The power source is a battery pack housed in a case providing DC power to energize the light emitting bulbs. The DC power source may be a battery pack, a plurality of batteries, a single battery, rechargeable or not rechargeable, or any combination thereof. The case may be formed from material comprising plastic, leather, etc. and is well known to those skilled in the art. The power source is sized such that it fits inside the housing 102. In the present embodiment, the power source is cylindrically shaped, however other shapes may also be used and are within the spirit and scope of the present invention, as long as the power source is able to fit inside the housing.

Referring to FIGS. 1-3, in operation, a user may install and remove a battery power source by hand. In other embodiments, a user may choose to turn on or off the lights using a remote actuator or switch. As light is transmitted through the translucent polyurethane exterior elements, the handlebar 102 is illuminated and the bicycle can be seen by others from the outside.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

We claim: CLAIMS

1. An illuminated handlebar for a bicycle, the handlebar comprising:
a hardened metal core comprising at least one elongated element;
a translucent polyurethane exterior disposed over at least a portion of the hardened metal core;
a portable DC voltage source coupled to a portion of the hardened metal core, wherein the voltage source is configured for installation and removal by a hand of a user without the use of tools;
a plurality of light emitting diode (LED) units conductively coupled to the voltage source, wherein the plurality of LED units contact at least a portion of the polyurethane exterior such that light emitted forwardly therefrom generally travels along the polyurethane exterior;
a switch for turning the plurality of LED lights on and off; and
a fastening element coupled to the hardened metal core for coupling to a stem of a bicycle.

2. The illuminated handlebar of claim 1, further comprising a reflector for collimating light emitted from the plurality of LED units forwardly therefrom and generally along the polyurethane exterior.

3. The illuminated handlebar of claim 2, where the plurality of LED units are colored LED units.

4. The illuminated handlebar of claim 3, wherein the plurality of LED units emit light in a plurality of timed sequences.

5. The illuminated handlebar of claim 4, wherein the DC power source is rechargeable.

6. The illuminated handlebar of claim 5, wherein the plurality of LED units are positioned such that light emitted from the plurality of LED units is substantially equally distributed along the polyurethane exterior.

7. An illuminated handlebar for a bicycle, the handlebar comprising:
a housing located at a midpoint of the handlebar and configured for coupling to a stem of a bicycle;
a portable DC voltage source located within the housing, wherein the voltage source is configured for installation and removal by a hand of a user without the use of tools;
a first elongated element comprising a hardened metal core coupled to a left side of the housing and extending out in the left direction from the housing;
a second elongated element comprising a hardened metal core coupled to a right side of the housing and extending out in the right direction from the housing;
a translucent polyurethane exterior disposed over at least a portion of the first and second elongated elements;
a plurality of light emitting diode (LED) units conductively coupled to the voltage source, wherein the plurality of LED units contact at least a portion of the polyurethane exterior such that light emitted forwardly therefrom generally travels along the polyurethane exterior; and
a switch for turning the plurality of LED lights on and off.

8. The illuminated handlebar of claim 7, further comprising a reflector for collimating light emitted from the plurality of LED units forwardly therefrom and generally along the polyurethane exterior.

9. The illuminated handlebar of claim 8, where the plurality of LED units are colored LED units.

10. The illuminated handlebar of claim 9, wherein the plurality of LED units emit light in a plurality of timed sequences.

11. The illuminated handlebar of claim 10, wherein the DC power source is rechargeable.

12. The illuminated handlebar of claim 11, wherein the plurality of LED units are positioned such that light emitted from the plurality of LED units is substantially equally distributed along the polyurethane exterior.
